(19) United States
(12) Patent Application Publication
(10) Pub. No.: US 2005/0235315 A1
(43) Pub. Date: Oct. 20, 2005

(54) Use of rotating banners for items in grid epg

(76) Inventor: Keith Baker, EINDHOVEN (NL)

Correspondence Address: PHILIPS INTELLECTUAL PROPERTY & STANDARDS, P.O. BOX 3001, BRIARCLIFF MANOR, NY, 10510, US

(21) Appl. No.: 10/518,839

(22) PCT Filed: Jun. 12, 2003
(86) PCT No.: PCT/IB03/02739

§ 371 Date: Dec. 21, 2004

(30) Foreign Application Priority Data
Jun. 27, 2002 (EP) 02077550.8

(51) Int. Cl. H04N 5/445

(52) U.S. Cl. 725/44; 725/39

(57) ABSTRACT

A method and apparatus for displaying information in cells of a grid electronic program guide is disclosed. A banner with the information for each cell of the grid electronic program guide is first stored in a memory. One or more cells are then selected. The banner in each selected cell is then rotated to display the banner a predetermined number of times.

### FIELD OF THE INVENTION

The invention relates to an electronic program guide and more particularly to using revolving banners in grid electronic program guides for displaying individual program data.

### BACKGROUND OF THE INVENTION

Grid electronic program guides (EPG) are the most frequently used format for the presentation of program guide information on digital television systems. The advantage of grid EPGs is that the representation of the broadcast channel data and content are provided to the viewer in a directly understandable format. For example, the television schedule information is presented in a program guide having a schedule information area depicting the programs that are being shown on each channel for a period of time, e.g., a day, a week, etc. FIG. 1 illustrates a typical grid EPG 100 which includes a schedule information area 102 having a program matrix 104 of cells or items that depict the shows that are being presented on each channel at each time of the day. The program guide 100 conveniently lists the channels in a vertical column to the left of the program matrix 104 and the times in a horizontal row above the program matrix 104.

A television schedule system may include an input device, such as a remote control device, pointing device, mouse, keyboard, microphone or the like, to enable the user to browse through the schedule information area and/or obtain more information about programs of particular interest. A controller may comprise a trackball, cursor controller, pointing device, a microphone for allowing voice activation, a number of keys or buttons that function to move the viewer around the screen, or the like. For example, the controller comprises a scrolling mechanism for displacing a movable cursor through a matrix of cells or windows on a screen. The cursor may comprise a physical icon on the screen, or it may be represented by highlighting or other visual indications of the cells or windows that are scrolled through by the viewer.

Unfortunately, a major problem with grid EPGs is that individual program data (the title of the program) has to be presented in a very condensed form. Thus, in a typical grid EPG, the titles of the programs will have to be presented in a truncated form as is illustrated in FIG. 1. One method of providing more information is to allow the pointing device to highlight a particular cell, and in a separate window to provide more detailed information about the highlighted show. An example of this method is illustrated in U.S. Pat. No. 5,793,438. One disadvantage of this method is that it requires complex control of the focus control in the grid. Thus, there is a need for a method and apparatus for providing more information in a grid electronic program guide without the need for complex control systems.

### OBJECT AND SUMMARY OF THE INVENTION

It is an object of the invention to overcome the above-described deficiencies of the known electronic program guides by allowing more information to be displayed on each cell by allowing the information in each individual grid cell to be stored as a banner. In a banner, the text in the cell is rotated across the display area of the cell to allow the text to be read in full by the viewer.

According to one embodiment of the invention, a method and apparatus for displaying information in cells of a grid electronic program guide is disclosed. A banner with the information for each cell of the grid electronic program guide is first stored in a memory. A column of cells is then selected. The banner in each cell in the selected column is then rotated to display the banner a predetermined number of times.

These and other aspects of the invention are apparent from and will be elucidated with reference to the embodiments described hereinafter.

### BRIEF DESCRIPTION OF THE DRAWINGS

FIG. 1 illustrates a known electronic program guide;

FIG. 2 is a block schematic representation of a representative television system on which the electronic program guide of the invention can be used;

FIG. 3 is a schematic representation of a known remote control unit;

FIG. 4 is a schematic representation of the internal circuitry of a known set-top box;

FIGS. 5a-5i are a series of frames illustrating a title of a program stored as an animated GIF according to one embodiment of the invention;

FIG. 6 is a flowchart illustrating the use of revolving banners for items in an EPG grid according to one embodiment of the invention.

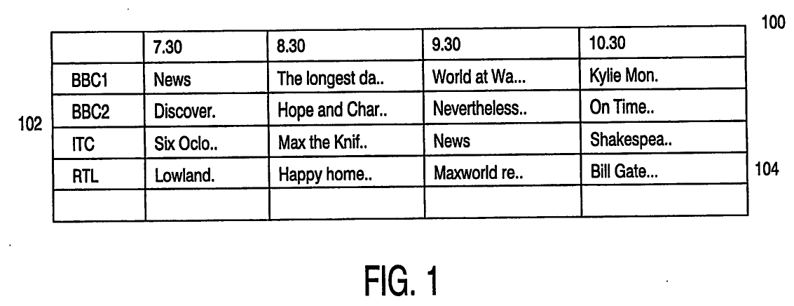

### DETAILED DESCRIPTION OF EMBODIMENTS

The electronic program guide of the invention can be implemented on a personal computer, a PCTV, a television connected to a set-top box, or a television including a custom board. It will be understood by those skilled in the art that the invention is not limited to any particular hardware configuration. According to the embodiments of the invention, the television system just needs the ability to display an electronic program guide.

As is well known in the art, the information to be displayed on the television system may be transmitted as an analog signal or as a digital signal modulated onto an analog carrier. The signals may be received via a cable, or via an antenna or satellite dish. Typically, television sets are designed to receive analog signals, and computer display devices are designed to display pictures encoded in a digital format. However, a decoder system can convert the digital data to an analog signal for display on a television set, and TV modems can format analog TV signals for display on a monitor.

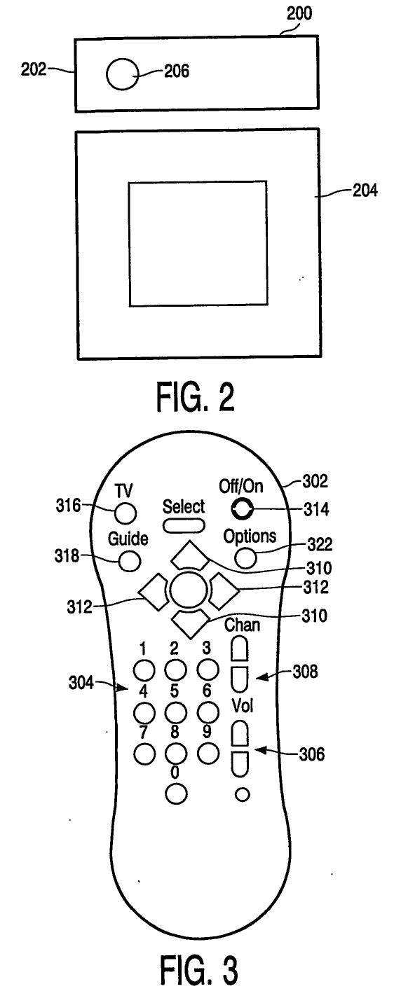

FIG. 2 illustrates a set-top box and a television combination 200 suitable for implementing the invention, but the invention is not limited thereto. The set-top box 202 is coupled to a broadcast medium (not illustrated) and to a broadcast signal input of a television 204. The set-top box 202 operates to select a particular channel to be received and to display programming of that channel through the television 204. According to some of the embodiments of the invention, the set-top box includes an IR receiver 206, or the like, operative to receive remote control signals from a remote control unit. A viewer may select a particular channel to be received by commanding the set-top box 202 via the remote control or by manually operating controls (not illustrated) on the set-top box 202. The set-top box 202 may also incorporate circuitry to allow the set-top box 202 to generate its own displays to be shown on the screen of the television 204.

As noted above, a set-top box is only one possible apparatus for implementing the invention. For example, all or part of the electronic program guide generating system of the invention may be located within the television 204 or within an interactive television network coupled to the set-top box 202. The set-top box 202 may be understood to be only one type of terminal adapter coupling a display terminal to a medium carrying a plurality of information streams such as video programs. Thus, a computer coupled to a network and a monitor could also be used to implement the invention.

FIG. 3 illustrates an exemple of a remote control unit 302 suitable for use in accordance with at least one embodiment of the invention. The remote control unit 302 includes a numeric keypad 304, volume controls 306, channel controls 308, vertical cursor arrow keys 310, horizontal cursor arrow keys 312, an on/off switch 314, a TV button 316, a guide button 318, a select button 320, and an options button 322.

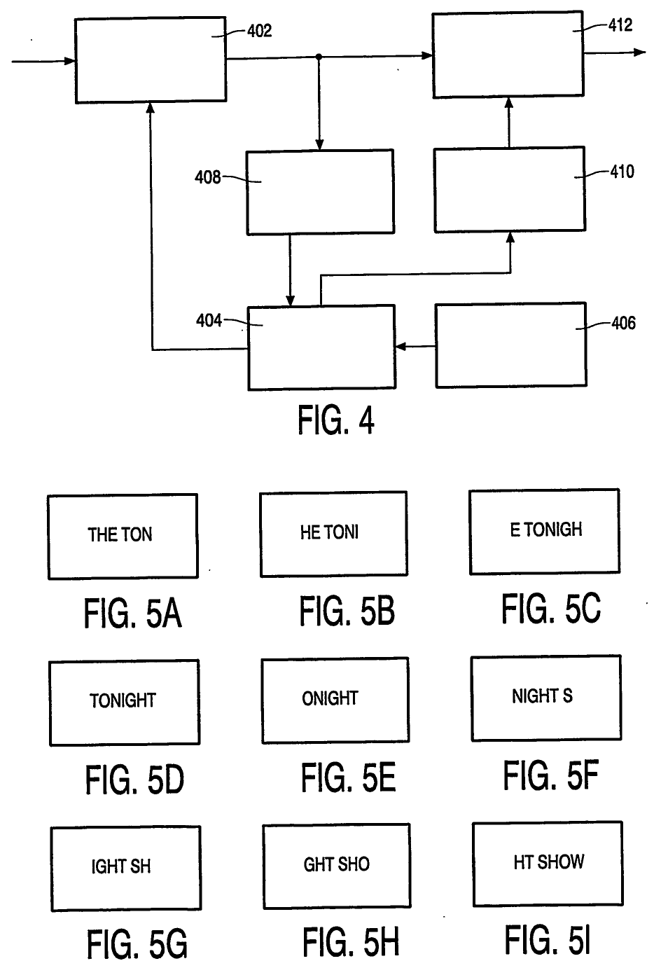

FIG. 4 illustrates a simplified representation of the operation of internal circuitry of the set-top box 202. The set-top box 202 includes a tuner/decoder 402, a control unit 404, a remote control receiver 406, a program guide information extraction unit 408, a program guide display generation unit 410, and a presentation unit 412. The remote control receiver 406 is coupled to the IR receiver 206 and converts the received IR signals to electric command signals which are input into the control unit 404. The control unit 404 coordinates the general operation of the set-top box 202 and preferably incorporates a microprocessor or microcontroller. One function of the control unit 404 is to generate a channel selection control signal to the tuner/decoder 402. The tuner/decoder 402 receives the external information signal, such as a video signal, and isolates a desired channel in accordance with the channel selection control signal.

The program guide extraction unit 408 isolates program guide information from the received signal. For example, this information can be extracted from the blanking intervals of the currently selected channel. It will be understood that there are other ways of multiplexing the program guide information with video information for display.

The control unit 404 also directs the program guide generation unit 410 to generate electronic program displays and prompts in response to the program guide information made available by the program guide extraction unit 408 and the user commands received via the remote control receiver 406. The presentation unit 412 combines the program guide display generated by the display generation unit 410 with the video signal received from the tuner/decoder 402 to produce a video signal for display. Further details of the internal design of the set-top box 202 will be understood by those skilled in the art and will not be further discussed herein. Any combination of hardware and software may be used to implement the functions of the set-top box 202.

According to one embodiment of the invention, revolving banners are used for items, for example, titles of programs, in a grid EPG so as to enable the viewer to fully read the items in the grid. One method of implementing this invention is to create each item as an animated GIF (Graphics Interchange Format). The animated GIF contains the image of the title in a number of steps or frames as illustrated in FIGS. 5a-5i. In FIGS. 5a-5i, the title “THE TONIGHT SHOW” is stored in a series of frames 502 which can be displayed sequentially to create the revolving banner in the cell of the electronic program guide. The GIF image can be triggered, for example, by the Java code of a digital television XLET application, but the invention is not limited thereto. When the animated GIF is triggered, the image in the particular cell in the grid changes as the frames of the animated GIF are sequentially shown. Thus, the display of the grid items is based on an array of GIF images that can be independently triggered to execute the movement of the display in a highly efficient form on the graphical display of the screen.

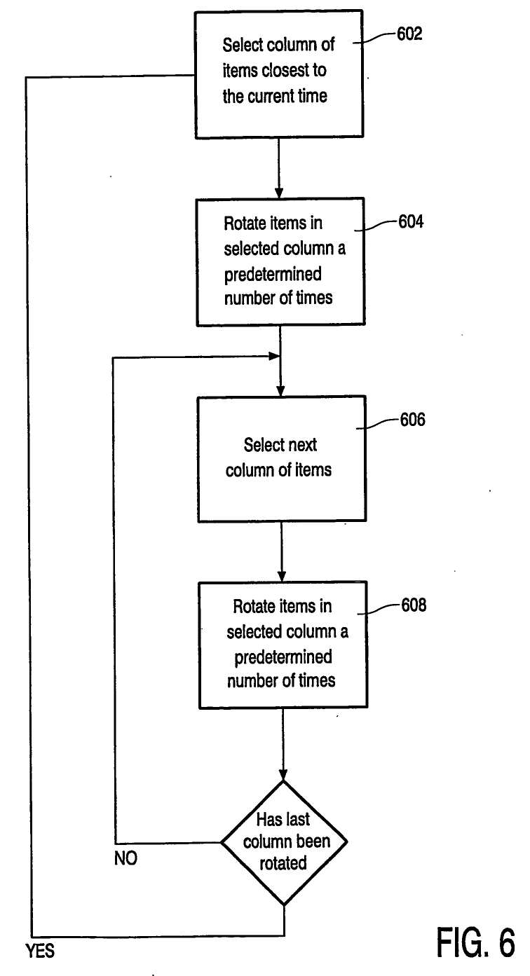

According to one embodiment of the invention, all of the items in the cells of the grid can be revolved at the same time. However, this may create a highly disruptive visual image. According to another embodiment of the invention, the item in each cell in a single column (or row) can be rotated at the same time as will be explained with reference to FIG. 6. In this exemple of an embodiment, the control unit 404 selects the column of items on display closest to the current time to be rotated first in step 602. The items in the column can be rotated a predetermined number of times, for example, 1, 2, 3, . . . , in step 604. Then, either autonomously or by a given signal from the user, the next column can be rotated in step 606. The second column will then be rotated a predetermined number of times in step 608, and the process would then be repeated for the next column. This process would continue until it is determined in step 610 that the last column has been rotated the predetermined number of times. The process can be interrupted at any time by the user who gives a command to hold or select. After all of the columns of the grid have been shown, the process can again start with the column closest to the current time. In addition, the entire process could stop if the complete grid has been shown a predetermined number of times.

According to another embodiment of the invention, the remote control unit could be used to move a pointer over the grid on the screen. In this embodiment, the pointer can be used to trigger the animated GIF of a particular cell. Thus, only the cell at which the pointer is pointing will have an activated revolving banner. Alternatively, the pointer could be used to activate an entire row or column of the grid, wherein the banners in all of the cells in the selected row or column are activated.

According to another embodiment of the invention, the triggering of a revolving cell could be based on a sequence that attempts to draw attention to specific cells, by appearing to rotate cells in an unbiased form, but in fact to rotate the cells in a manner that actually makes some titles easier to read. This could be done by changing the speed and duration of rotation, by jittering the rotating speed to make reading of the title more difficult, or by repeating the rotation of some cells more frequently.

It will be understood that the different embodiments of the invention are not limited to the exact order of the above-described steps as the timing of some steps can be interchanged without affecting the overall operation of the invention. Furthermore, use of the verb “comprise” and its conjugations does not exclude other elements or steps, while use of the article “a” or “an” does not exclude a plurality of elements or steps, and a single processor or other unit may fulfil the functions of several of the units or circuits recited in the claims.

1. A method of displaying information in cells of a grid electronic program guide, the method comprising the steps of:
storing a banner with the information for each cell of the grid electronic program guide;
selecting at least one cell; and
rotating the banner in each cell in the at least one selected cell to display the banner a predetermined number of times.

2. The method as claimed in claim 1, wherein the banner for each cell is an animated GIF file.

3. The method according to claim 1, wherein the at least one cell is a column of cells.

4. The method according to claim 1, wherein the at least one cell is a row of cells.

5. The method according to claim 3, wherein the column of cells closest to the current time is selected.

6. The method according to claim 5, further comprising the step of:
selecting successive columns of cells, starting with the column representing a second closest to the current time and rotating the banners in the selected column of cells a predetermined period of time.

7. The method according to claim 1, wherein the at least one cell is selected by the user.

8. The method according to claim 7, wherein the user selects the at least one cell by using a pointing device.

9. The method according to claim 1, further comprising the step of:
jittering the rotation speed of some banners to make the banners more difficult to read.

10. An apparatus for displaying information in cells of a grid electronic program guide, the apparatus comprising:
means for storing a banner with the information for each cell of the grid electronic program guide;
means for selecting at least one cell; and
means for rotating the banner in each cell in the at least one selected cell to display the banner a predetermined number of times.

11. The apparatus according to claim 10, wherein the banner for each cell is an animated GIF file.

12. The apparatus according to claim 10, wherein the at least one cell is a column of cells.

13. The apparatus according to claim 10, wherein the at least one cell is a row of cells.

14. The apparatus according to claim 12, wherein the column of cells closest to the current time is selected.

15. The apparatus according to claim 14, further comprising:
means for selecting successive columns of cells, starting with the column representing a second closest to the current time and rotating the banners in the selected column of cells a predetermined period of time.

16. The apparatus according to claim 10, wherein the at least one cell is selected by the user.

17. The apparatus according to claim 16, wherein the user selects the at least one cell by using a pointing device.

18. The apparatus according to claim 10, further comprising:
means for jittering the rotation speed of some banners to make the banners more difficult to read.

19. A computer program product enabling a programmable device, when executing said computer program product, to function as an apparatus as defined in claim 10.
